(19) United States
(12) Patent Application Publication
(10) Pub. No.: US 2002/0191028 A1
(43) Pub. Date: Dec. 19, 2002

(54) Window manager user interface

(76) Inventors: David A. Senechalle, Perkiomenville, PA (US); Brian Noyes, Pensacola, FL (US)

Correspondence Address: BLANK ROME COMISKY & MCCAULEY, LLP, 900 17TH STREET, N.W., SUITE 1000, WASHINGTON, DC, 20006, US

(21) Appl. No.: 09/883,506

(22) Filed: Jun. 19, 2001

(51) Int. Cl. G06F 3/14

(52) U.S. Cl. 345/800

(57) ABSTRACT

A window manager has a frame window, with one or more pane windows. Each pane window has a viewing area that is used to display an application. If the application running in the viewing area cannot be fully viewed, a scroll bar and scroll keys are provided to enable the user to scroll through the entire application. The user can quickly and easily create and remove pane windows within the frame window. Pane windows are created by splitting an existing pane window either vertically or horizontally, with the two new split pane windows occupying the space of the original pane window. When a pane window is closed, one or more of the remaining pane windows are maximized to occupy its space. Accordingly, the window manager enables the pane windows to be dynamically and simultaneously presented to a user. The pane windows do not interfere with one another, and are arranged to maximize the space available in that frame window.

### BACKGROUND OF THE INVENTION

1. Field of the Invention

The present invention relates to a user interface and method for managing windows. More particularly, the present invention relates to a window manager used to simultaneously run and display multiple views of a single application or multiple applications.

2. Description of the Related Art

When users are monitoring or controlling multiple real time processes within a single application, each process is typically positioned within a separate window. In addition, when a user is operating multiple applications, each of those applications is positioned within a separate window. A problem therefore arises of how to best present the various windows involved.

Traditional user interfaces confine the user to essentially one window at a time. The user must then switch between the various windows by, for instance, selecting that window from the taskbar, or by minimizing the focus window and maximizing or restoring the desired window.

One type of window management system is referred to as Multiple Document Interface (MDI). MDI is used for window management within Microsoft Windows applications. Multiple child windows can be opened within a parent frame window. The child windows are overlapping windows within the bounds of the frame window, and can be resized and rearranged. However, the user must arrange the child windows so that the bounds of the parent window are used efficiently.

MDI allows child windows to be maximized within the frame window, but only the current active or focus window can be maximized within the frame window and the remaining non-focused windows are hidden. To be seen, a hidden window must be activated or focused, which brings it to the front and hides the previously-focused window and other non-focused windows. Consequently, MDI requires the user to conduct a great deal of resizing and rearranging to achieve a layout of multiple windows.

Another type of window management system is referred to as a fixed split application. This system is used to arrange different views of data and controls within a parent window. However, these applications are limited to a fixed number of predefined splits that can occur. For instance, in Microsoft Outlook or Windows Explorer, the user can select a folder view to be displayed in a split window on the left. The content of whatever is selected in the left window is displayed in the right window. Other applications, such as Rational Rose or Borland JBuilder, present more than one split. However, the number, layout and selection of those splits is predefined, and the user is limited to just resizing the existing splits, not creating new ones.

A third type of window management system is referred to as the grid layout window. Many applications allow the user to automatically arrange open windows using a command known as “tile.” The tile command lays out the open windows in a grid, tiling them either horizontally, vertically, or in a grid. The grid layout, however, enforces a rectangular grid of windows, and does not permit sub-splitting outside of that layout. The user cannot resize a single pane, but can only alter the width of an entire row or column of similarly aligned panes. In addition, the user must re-initiate the tile command as new windows are created or removed.

Thus, these conventional user interfaces are either static or at best have a limited ability to create a separate window that overlaps with the first window. The prior systems require excessive user manipulations in order to manually layout the windows to maximize the use of the display screen. In addition, those prior art systems limit the number, layout and selection of windows that can be divided. Consequently, prior methods are clumsy, inflexible, and do not allow the user to easily view more than one window at a time.

### SUMMARY OF THE INVENTION

In view of the foregoing, one object of the present invention is to provide a user interface for managing windows that is easy to use. Another object of the invention is to provide a user interface for managing windows that is flexible, and allows the user to simultaneously view multiple windows. Yet another object of the invention is to provide a window management system that does not limit the number of splits the user creates, the nesting scheme of those splits, or the resizing of the splits.

Still another object of the invention is to provide a window management system that automatically and dynamically arranges pane windows without user interaction, especially during creation and removal of pane windows. Another object of the invention is to provide a GUI framework for managing multiple real time processes from within a single or multiple frame windows without requiring the user to constantly switch between frame windows.

The window manager generally has a frame window, with one or more pane windows. Each pane window has a viewing area that is used to display an application. All of the pane windows are simultaneously presented to the user within the frame window. The pane windows do not interfere with one another, and are arranged to maximize the utilization of the space available in that frame window. If the application running in the viewing area cannot be fully viewed, a scroll bar and scroll keys are provided to enable the user to scroll through the entire viewing area.

The user can quickly and easily create and remove pane windows within the frame window. Pane windows are created by splitting an existing pane window either vertically or horizontally, with the two new split pane windows occupying the space of the original pane window. When this is done, the original view occupies one of these split panes, and the other pane becomes available for an additional view. When a pane window is closed, one or more of the remaining pane windows are maximized to occupy its space. Accordingly, the window manager enables the pane windows to be dynamically and simultaneously presented to a user in a manner that maximizes the utilization of the space available in the frame window. As pane windows are split and closed, the window manager dynamically maximizes the resulting arrangement.

These and other objects of the invention, as well as many of the intended advantages thereof, will become more readily apparent when reference is made to the following description, taken in conjunction with the accompanying drawings.

### BRIEF DESCRIPTION OF THE DRAWINGS

FIG. 1 shows a frame window having multiple pane windows in accordance with the preferred embodiment of the invention.

FIG. 2 is a flow chart depicting the overall operation of the window manager.

FIG. 3 is a flow chart showing the operation for inserting a pane window into the frame window.

FIG. 4 is a flow chart showing the operation for splitting a pane window.

FIG. 5 is a flow chart showing the operation for closing a pane window.

FIG. 6 is a flow chart showing the operation for floating a pane window.

FIG. 7 is a flow chart showing the operation for swapping views between two pane windows.

FIG. 8 is a flow chart showing the operation for moving a view into a new split pane window.

FIG. 9 is a flow chart showing the operation for resizing a pane window.

### DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected.

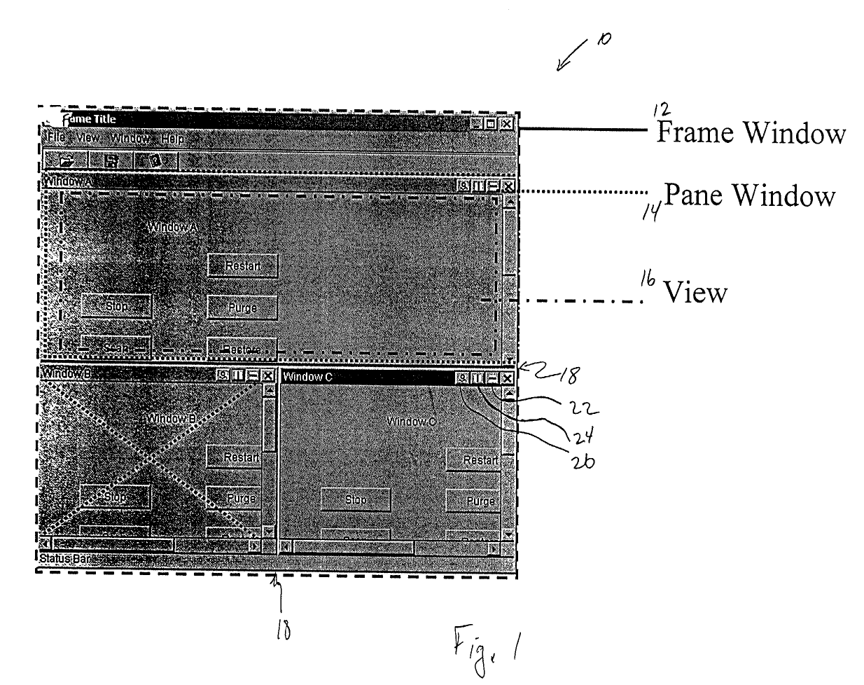

Turning to the drawings, an overview of the window manager 10 is shown in FIG. 1. The window manager 10 generally has a frame window 12, with one or more pane windows 14. Each pane window 14 has a viewing area 16 that is used to display an application. All of the pane windows 14 are simultaneously presented to the user within the frame window 12. The pane windows 14 do not interfere with one another, and are arranged to maximize the utilization of the space available in that frame window 12. If the application running in the viewing area 16 cannot be fully viewed, a scroll bar and scroll keys are provided to enable the user to scroll through the entire application.

The pane windows 14 are separated by one or more posts 18 that define boundaries between the pane windows 14. The posts are not visible to the user, and are only included in the figure to best illustrate and describe the invention.

Each pane window 14 is also provided with accelerator keys or command icons 22, 24 and 26. The command icons 22, 24, 26, permit the user to control the number and position of the frame windows 12 and pane windows 14. The horizontal split command 22 divides the pane window 14 into two horizontally-aligned pane windows 14. The vertical split command 24 divides the pane window 14 into two vertically-aligned pane windows 14. The division is preferably into two equal parts, though any suitable division can be made, such as into more than two pane windows, or into pane windows that are unequal in size.

The float command 26 removes the pane window 14 from the frame window 12. The view that was removed from the frame window 12 then appears as the only view of a new frame. The “floated” pane window 14 is then referred to as a secondary frame window 12 and the frame window 12 from which it was created is referred to as the primary frame window 12. The secondary frame window 12 is no longer within the confines of the primary frame window 12, and therefore the primary and secondary frame windows can overlap one another. The secondary frame window 12 can be further divided into one or more pane windows 14 (divisible mode), or can be designed as being non-divisible (non-divisible mode).

Under the divisible mode of operation, the secondary frame window 12 has the life of the primary frame window 12, so that if the primary frame window 12 is closed, then the secondary frame window 12 is automatically closed. However, the life of the primary frame window 12 is independent of the life of the secondary frame window 12, so that if the secondary frame window 12 is closed, the primary frame window 12 remains focused. Under the non-divisible mode of operation, either frame window 12 can be closed without closing the other frame window 12. If the last remaining frame window 12 is closed, the application ends.

The embodiment of FIG. 1 includes one frame window 12 and three pane windows 14, which are labeled as Window A, Window B and Window C. When the frame window 12 is initially opened, the pane window, Window A, encompasses the entire frame window 12. At that time the user selected to split Window A horizontally. As a result two horizontally-aligned pane windows were created, and separated by the long horizontal post 18 that extends the entire width of the frame window 12. Next, the lower pane window was split vertically, creating Window B and Window C, which are separated by the vertical post 18.

After each pane window 14 was created, the user opened an application in the view 16 of that pane window 14. For simplicity, each of the pane windows 14 is shown having the same application. The buttons Restart, Stop, Purge, Scan and Restore relate to the operation of that application. However, the pane windows 14 can each have different applications that operate simultaneously.

The frame window 12 includes a toolbar that enables the user to perform standard operations, such as to start an application, close an application, or print, in the focused pane window. The user can also save the frame window 12 configuration, including the arrangement of pane windows 14, and the current application parameters.

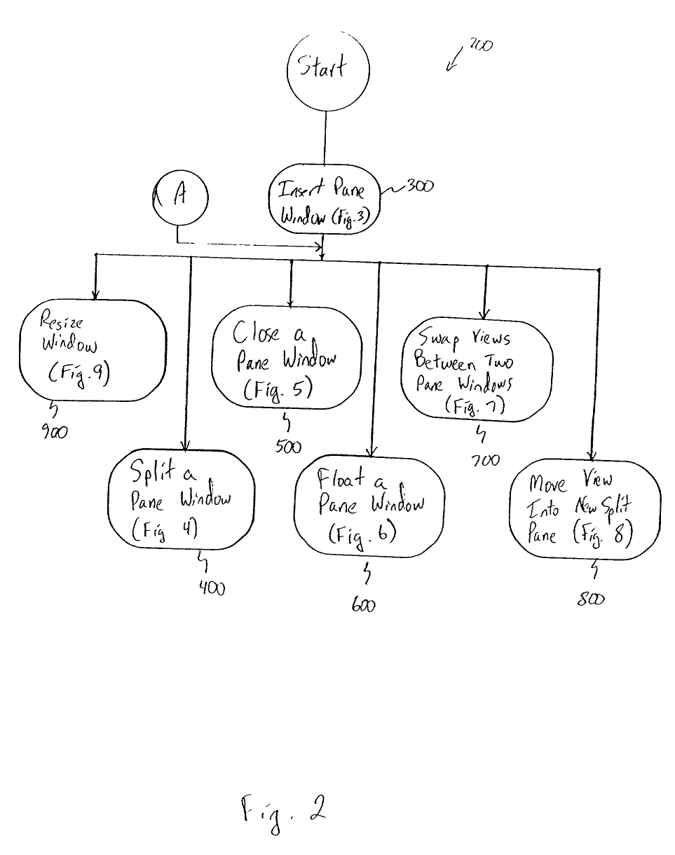

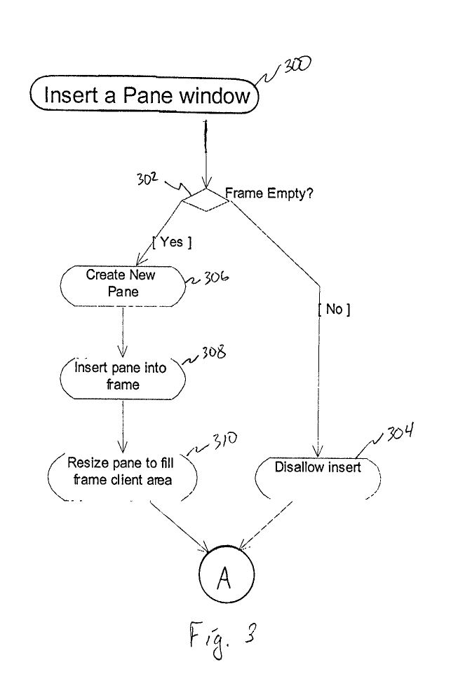

The operation of the system will now be discussed with reference to FIG. 2, where the overall operation of the system is shown at 200. The user starts the application and opens a frame window 12. At this point, the user can either open a pane window 14 or a configuration that was previously saved by the user. If the user chooses to insert a pane window 300, operation continues at step 302 of FIG. 3. At step 302, the window manager 10 determines whether the frame window 12 is empty. If the frame window 12 is not empty, such as when the user opens a saved configuration, the pane window 14 is not inserted into the frame window 12, step 304, and operation returns to point A of FIG. 2.

On the other hand, if the frame window 12 is empty at step 302, then the new pane window is created, step 306, and inserted into the frame window 12, step 308. The newly-created pane window 14 is sized to fill the frame window 12, step 310. Operation then returns to point A of FIG. 2. In an alternative embodiment, the window manager 10 can automatically open a pane window 14 when the frame window 12 is opened. If the user wishes to use a saved configuration, that configuration is restored.

Once the pane window 14 has been opened, either by inserting the pane window 300, opening a saved configuration, or being automatically opened by the window manager 10, the user has the following options: split a pane window 400, close a pane window 500, float a pane window 600, swap views between two pane windows 700, move view into new split pane window 800, or resize a frame window or pane window 900. These options continue until the last pane window 14 or the frame window 12 is closed.

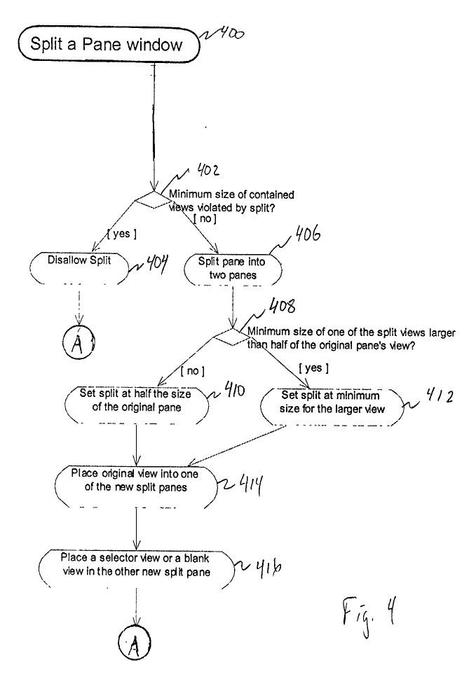

If the user chooses to split a pane window 14, step 400, processing continues in FIG. 4. The user may choose to split a pane window 14 by selecting the horizontal split command or the vertical split command from the pull-down program menu or via the shortcut command icons 22, 24, respectively. At step 402, the system then analyzes the pane window 14 that is to be split to determine whether the split would violate the minimum size of that pane window 14. The window manager 10 automatically sets the minimum size for each pane window 14 when the pane window 14 is created. However, that preset size can be reprogrammed by the user. The minimum size ensures that the application running in that pane window 14 will have a sufficient size to be viewable to the user. Accordingly, if the split would result in the pane window 14 having a size less than a preset or predetermined size for that window, the split is disallowed, step 404, and operation returns to point A of FIG. 2.

Assuming the minimum size for the pane window 14 to be split would not be violated, step 402, the window manager 10 then splits that pane window into two pane windows, step 406. The split is made horizontally or vertically, depending on whether the user chose the horizontal or vertical split command 22, 24. The split creates two pane windows 14 in the space that was previously occupied by the single pane window 14.

The window manager 10 then determines whether the minimum size of one of the views is larger than one-half of the original space of the original pane window, step 408. This would occur, for instance, if the original view has a smaller minimum size than the view inserted by default into a new split pane window. As long as the sum of the minimum widths and heights of the two split pane windows is less than the width and height of the original pane window, the split is allowed to occur. If the minimum width and height for one of the split windows exceeds one-half of the respective width and height of the original pane window, the widths and heights for the split pane windows are set at the larger of the two minimum widths and heights, step 412. Otherwise, the split is set at one-half the size of the original pane window, step 410. However, if the minimum width and height for each of the split views exceeds one-half of that of the original pane window, the split is disallowed.

Once the original pane window is split into the two pane windows 14, the original view is placed into one of the new split pane windows, step 414. At step 416, the other pane window 14 can have a blank view, or contain a selector view that enables the user to open an application into that pane window 14. The window manager 10 can be set to define which pane window will contain the original view, and the user can move the view into the empty pane window. The system operation then returns to point A in FIG. 2.

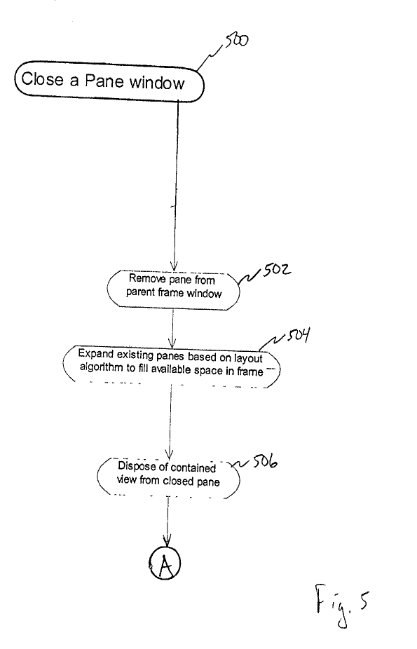

If the user at any time decides to close a pane window 14, operation proceeds at step 500 of FIG. 5. The user can close a pane window 14 by selecting the close command from the pull-down program menu or via a shortcut command icon located within that pane window 14. Once the user selects to close a pane window 14, that pane window is removed from the frame window 12, step 502. The remaining pane windows 14 are then expanded to fill the space that was previously occupied by that closed pane window, step 504, and the closed window view is disposed or returned to a framework that resides at a higher level than the window manager, step 506. The operation of the system then returns to point A in FIG. 2. However, if the pane window was the only pane window in the frame window 12, then the window manager 10 waits for a new pane window to be inserted 300, FIG. 2. Alternatively, the window manager 10 can prevent the last pane window 14 from being closed.

Accordingly, the window manager 10 maximizes the space within a frame window 12. Preferably, the window manager 10 expands one or more neighboring pane windows 14 that have the same height and/or width. For instance, if the user closes Window B of FIG. 1, Window C would be expanded to the space occupied by Window B since Window C has the same height as Window B. Window A would remain unchanged. If, on the other hand, Window A were closed, then both Windows B and C could be expanded vertically to occupy the space of Window A.

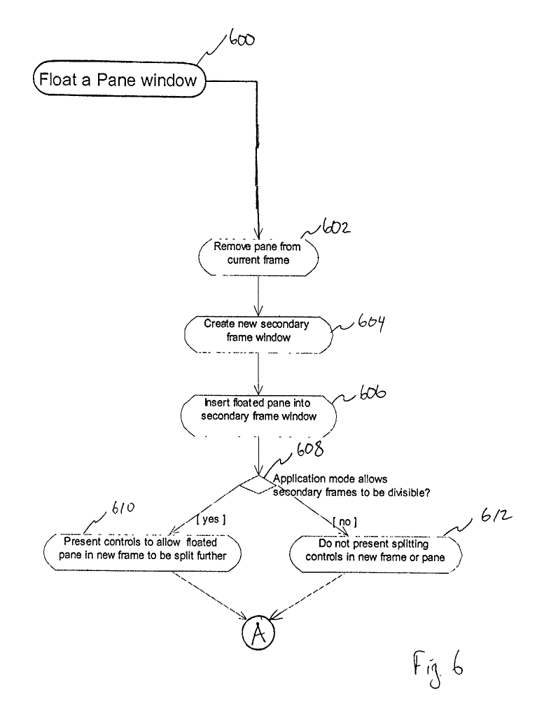

If the user chooses to float a pane window 14, step 600, processing continues in FIG. 6. The user may choose to float a pane window 14 by selecting the float command from the pull-down program menu or via the shortcut float command icon 26. When a user decides to float a pane window 14, the pane window 14 is removed from the current frame window 12, step 602, in the same manner as for closing a pane window, namely steps 502-506 (FIG. 5). In addition, a secondary frame window 12 is created, step 604, and the pane window 14 is inserted into the secondary frame window 12, step 606. Thus, the pane window 14 is removed from the primary frame window 12, and inserted into the new secondary frame window 12.

Since no other pane windows are in the secondary frame window 12, the pane window 14 that was floated is maximized to encompass the entire frame window 12. The window manager 10 can be programmed so that the secondary frame window 12 is either non-divisible, or that it can be divisible into further pane windows 14 and/or floated frame windows 12. If the secondary frame window 12 is divisible, step 608, the respective split and/or float commands are made available in the secondary frame window 12, step 610. Otherwise, the commands are not made available in the secondary frame window, step 612. Operation returns to point A of FIG. 2.

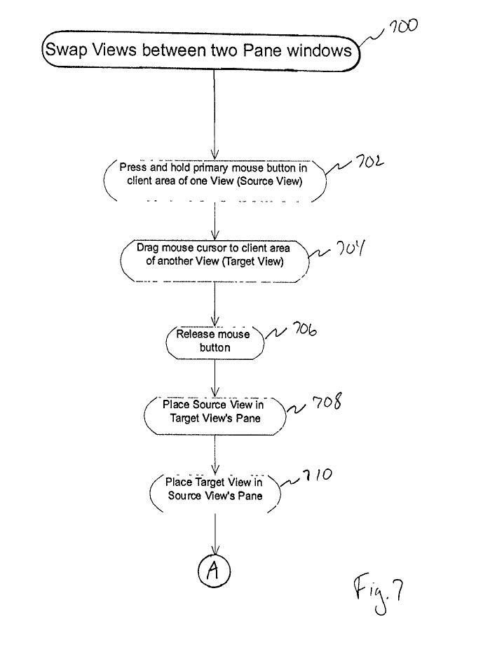

The user also has the option of switching views 16 between two pane windows 14, step 700, as detailed in FIG. 7. In other words, the user can switch the applications running in two different pane windows 14 by moving the applications to the other pane window 14. The two pane windows can be in the same frame window or in different frame windows. To do this, the user presses and holds the mouse button in the client area (that is, the application) of one pane window, step 702. The mouse cursor, and thus the application, is dragged into the target pane window 14, step 704, and released into the target pane window 14, step 706. The window manager 10 automatically switches the applications between the source pane window and the target pane window, steps 708, 710. The operation continues at point A of FIG. 2.

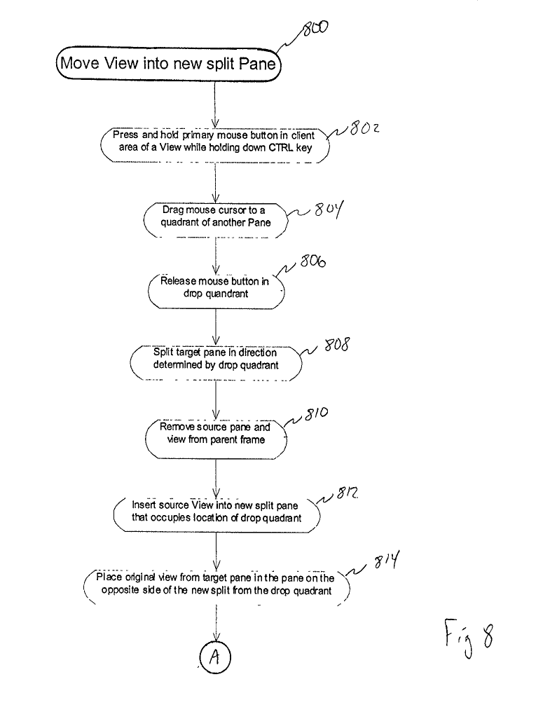

The user also has the option of moving a view 16 (that is, application or program) into a new split pane window 14 that may be in either the same frame window or a different frame window, step 800, FIG. 8. Here, the user is not only moving the view 16, but also closing the source pane window and creating a new split pane window at the same time. To do so, the user selects the source view, such as by pressing the mouse button on the view to be moved while holding down the CTRL key, step 802.

The mouse cursor, and thus the view, is dragged to another pane window 14, step 804, and released when the mouse button is released, step 806. Each pane window 14 is divided into four quadrants, as shown by the dashed X in Window B of FIG. 1. The pane window 14 is split in the direction identified by the quadrant in which the view was released, step 808. Thus, for instance, if the source view was released in the upper quadrant, the pane window 14 is split vertically. However, if the target pane window is in the non-divisible mode of operation, then the source pane window is deleted from the source frame window and the target pane window is replaced by the source pane window, and no split occurs. In addition, if the user releases the view into an empty pane window 14, there is no need to split that pane window 14, and the view is simply moved into that empty pane window.

After the pane window 14 is split, step 808, the source pane window 14 is removed from the parent frame window 12, step 810. The source pane window 14 is removed in the same manner as for closing a pane window, at steps 502-506 of FIG. 5. The view from the source pane window 14 is inserted into the new split pane window 14, which occupies the location of the drop quadrant, step 812. The view that occupied the target pane window is placed into the split pane window 14 that is opposite the drop quadrant, step 814. Operation proceeds at point A of FIG. 2.

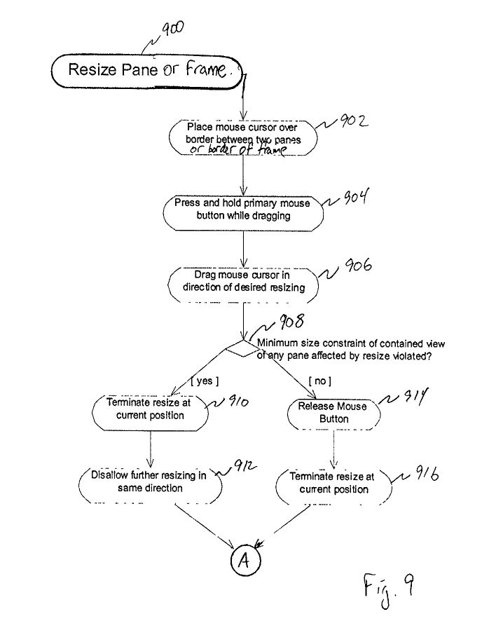

At any time, the user can resize a pane window 14 or frame window 12, step 900, FIG. 9. To do so, the user places the mouse cursor over the border between the pane windows 14 to be resized, or at the edge of the frame window 12 to be resized, step 902. A resizing guide will appear, and the user presses and holds the mouse button, step 904, and drags the border to the desired position, step 906. If the user is resizing the width of the pane window or frame window, the vertical border is dragged, but can only be dragged horizontally. If the user is resizing the height of the pane window or frame window, the horizontal border is dragged in a vertical direction. The user can also place the mouse cursor on a corner, and the resizing guide allows the user to simultaneously resize the horizontal and vertical dimensions.

If the user is resizing a pane window 14, the window manager 10 determines whether the minimum size constraint of any pane window would be violated, step 908. If the resizing would violate the minimum size constraint of a pane window, the resizing is terminated at the current position, step 910, and further resizing is disallowed in that direction, step 912. If the minimum size constraint is not violated, step 908, then the user eventually releases the mouse button, step 914, and the resizing is terminated at that position, step 916. Operation proceeds at point A of FIG. 2.

If the user is resizing a frame window 12, the window manager resizes the pane windows 14 along the bottom and right borders of the frame window 12 as the frame window 12 is resized. Only the pane windows at the right edge or bottom edge of the frame window are resized. Once these pane windows reach its minimum size in a particular dimension, step 908, the frame window cannot be made smaller in that dimension, step 910, until the user readjusts the size of that pane window. If the minimum size of the pane windows is not violated, the resizing is stopped at the position of the cursor when the user releases the mouse button.

Although resizing is preferably implemented by use of mouse control, resizing can also occur through the use of keyboard commands. The user can place the window manager 10 into a resizing mode through the use of a command key or key combination (such as CTRL-R). Once in the resizing mode, the arrow keys are used to first select which direction the window is being resized in, and then to resize the pane window 14. Another key, such as the ESC key, can complete the resizing operation. Keyboard commands can also be used to define which pane window is presently focused (such as CTRL-TAB to scroll through the various pane windows). Different keys can be used to control sizing of the frame window, as opposed to the pane windows.

Keyboard controls can also be used for the other functions, such as inserting a pane window 300, splitting a pane window 400, closing a pane window 500, floating a pane window 600, swapping views between two pane windows 700 and moving a view into a new split pane window 800. For instance, for swapping views and moving and splitting panes, a key combination is used to initiate the drag and drop operations, then the arrow keys are used to position the cursor, and another key combination completes the drag and drop operation.

Accordingly, the window manager enables the pane windows 14 to be dynamically and simultaneously presented to a user in a manner that maximizes the space available in the frame window 12. As pane windows 14 are split and closed, the window manager dynamically maximizes the resulting arrangement.

Though the applications running in each pane window 14 are operating simultaneously, the user can generally only work in one pane window 14 at a time. The pane window 14 that is focused is depicted by changing the color of the caption bar at the top of that pane window 14. For instance, the color of the caption bar is blue when focus resides in that pane window, and dark gray if the pane window last had the focus (such as during a menu selection or if another frame or application gets the focus) and light gray if the pane window does not have the focus. In the embodiment of FIG. 1, Window C is shown as having the focus, and Windows A and B are non-focused.

Any command chosen from the pull-down program menu is enacted on the pane window 14 having the focus. The user can select which pane window 14 is to be focused by clicking a mouse in that pane window 14, by selecting the pane window 14 from the pull-down program menu, or by using a key command that scrolls through the various pane windows 14.

At any time, the user can close the entire application, including all frame windows. At that time, the window manager saves the configurations of all the frame windows, including the layout of pane windows 14 for the primary frame window 12 and any secondary frame windows 12, as well as the settings for the applications running in each pane window 14. The saved configuration is automatically restored for the user whenever the application restarts.

If, during any of the operations 400-1000, that operation is interrupted or canceled by the user, the operation is canceled and the operation continues at point A of FIG. 2 as if the operation had not been undertaken.

Though the invention preferably splits a pane window into two pane windows, additional splits can be made. Accordingly, the user can specify any number of splits for a single operation. The pull-down menu can allow the user to select the desired number, and clicking on and holding down the command icon 22, 24 can result in a pull-down of the number of desired splits. Thus, for instance, the user can split a single pane window 14 into three equally sized pane windows in a single operation.

Another feature of the present invention is to provide a view selector interface into an empty pane window. The view selector interface permits the user to select a view (such as an application), which then replaces the view selector interface. However, the view selector interface can also be presented in a different pane window 14 or in a different frame window 12. The view selector interface can be designed to respond to messages from other program elements, such as from menu selection or a message sent by an application outside the control of the window manager.

In addition, a command is alternatively provided that permits the user to maximize any one or more pane windows 14 to encompass the entire frame window 12. The maximized pane window 14 hides the other pane windows 14. When the user restores (un-maximizes) a pane window 14, the window manager returns that pane window to its original size and position. If a pane window is closed from the maximized state, the new layout of the remaining pane windows is determined as if the removed pane windows were individually closed in the normal split layout.

The present invention can be used to simultaneously display a single application in the pane windows, or different applications in one or more pane windows. Additionally, the invention can be implemented within an application that otherwise does not have the window management features of the present invention, such as the ability to split pane windows. Toward this end, an Application Programming Interface (API) is provided that allows the user to quickly develop an application into a window manager. The application derives the classes from a specified set of classes that are implemented in the API.

The base classes provided by the API include an Application class and a Frame class. The user derives the application from the Application class and each frame from the Frame class. However, the view windows of the application are not restricted to being based on a class of the API. The user provides these views, whose function is to incorporate the information processing specific to the application. The application can provide whatever behavior and functionality is desired through the derived application, frame and view classes. The API classes themselves provide all the functionality of the window management.

The API provides the application with the functionality to handle window management, including inserting pane windows, splitting pane windows, removing pane windows, resizing pane windows and frame windows, floating pane windows into a new frame, swapping views between pane windows, and moving a pane window from one location into a new split in an existing pane window.

The API includes an application development wizard that allows the user to create a skeletal application by indicating certain information, such as application name, desired names for the derived classes, and the file names and locations for the created code files. At the completion of the application development wizard, code is created that is compiled and run to have an empty application that provides all the functionality of the window manager 10. The user then specifies the views that are to be inserted into the pane windows, and defines the events that occur in those views.

The foregoing descriptions and drawings should be considered as illustrative only of the principles of the invention. The invention may be configured in a variety of shapes and sizes and is not limited by the dimensions of the preferred embodiment. Numerous applications of the present invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

We claim:

1. A window management system, comprising:
a frame window;
at least one pane window located within said frame window, each at least one pane window occupying a respective space within said frame window and having a minimum pane window size; and,
a split command for dividing a selected one of said at least one pane window into two pane windows each having a minimum pane window size, said split command determining whether the minimum pane window size for the divided pane windows could fit within the space occupied by the selected pane window and, if so, then dividing the selected pane window into the two pane windows to occupy the entire space of the selected pane window.

2. The window management system of claim 1, wherein a unique application operates in each of a plurality of said at least one pane window.

3. The window management system of claim 1, wherein if the minimum pane window size for the divided pane windows cannot fit within the space occupied by the selected pane window, then the selected pane window is not divided into the two pane windows.

4. The window management system of claim 1, wherein said split command divides the selected pane window horizontally.

5. The window management system of claim 1, wherein said split command divides the selected pane window vertically.

6. The window management system of claim 1, wherein said at least one pane window cannot overlap with any other of said at least one pane window.

7. The window management system of claim 1, wherein all of said at least one pane windows are simultaneously displayed in said frame window.

8. The window management system of claim 1, wherein said window management system is implemented within an application.

9. A window management system, comprising a frame window, a plurality of pane windows located within said frame window, each of said pane windows having a view and simultaneously displayed in said frame window, and a move command for moving the view from a first pane window to a second pane window.

10. The window management system of claim 9, wherein said move command also moves the view from the second pane window to the first pane window.

11. The window management system of claim 9, wherein if the view of the second pane window is occupied, then splitting the second pane window into a third pane window having the view of the second pane window and a fourth pane window having the view of the first pane window.

12. The window management system of claim 11, wherein each of said plurality of pane windows is divided into sections and said move command comprises dragging the view from the first pane window to a selected one of the sections of the second pane window, the splitting of the second window being based upon the selected section.

13. The window management system of claim 9, further comprising deleting the first pane window.

14. The window management system of claim 9, wherein a unique application operates in each of a plurality of said plurality of pane windows.

15. A window management system, comprising:
a frame window;
a plurality of pane windows located within said frame window, each of said pane windows occupying a respective space within said frame window; and,
a close command for closing one of said plurality of pane windows, said close command closing said one of the plurality of pane windows and maximizing the remaining pane window or pane windows to occupy the entire space of the closed pane window.

16. A window management system, comprising a primary frame window, a plurality of pane windows located within said frame window, each of said pane windows occupying a respective space within said frame window and simultaneously displayed in said frame window, and a float command, said float command creating a secondary frame window, removing a selected pane window from within said primary frame window and locating the removed pane window in the secondary frame window.

17. The window management system of claim 16, wherein the secondary frame window is independent of said primary frame window.

18. The window management system of claim 16, wherein the secondary frame window is closed if the primary frame window is closed.

19. The window management system of claim 18, further comprising a plurality of views, each view located in one of the plurality of pane windows, and a move command for moving one of the views from its pane window into a different pane window.
